(19) United States
(12) Patent Application Publication
(10) Pub. No.: US 2026/0080546 A1
(43) Pub. Date: Mar. 19, 2026

(54) IMAGE PROCESSING METHOD AND ASSOCIATED IMAGE PROCESSING CIRCUIT

(71) Applicant: Realtek Semiconductor Corp., HsinChu (TW)

(72) Inventors: Yanting WANG, Suzhou City (CN); Guangyu SAN, Suzhou City (CN); Jianing DAI, Suzhou City (CN)

(73) Assignee: Realtek Semiconductor Corp., HsinChu (TW)

(21) Appl. No.: 19/296,991

(22) Filed: Aug. 12, 2025

(30) Foreign Application Priority Data
Sep. 19, 2024 (CN) 202411308421.0

(51) Int. Cl. G06T 7/246; G06T 3/40; G06T 7/254

(52) U.S. Cl. CPC G06T 7/248; G06T 3/40; G06T 7/254; G06T 2207/20224

(57) ABSTRACT

The present invention provides an image processing method, which includes the steps of: receiving an image signal, wherein the image signal includes a frame; performing motion estimation on multiple blocks of the frame to generate multiple first motion vectors of the multiple blocks; performing a scaling-down operation on the frame to generate a first scaled-down frame; performing the motion estimation on a first specific block of the first scaled-down frame to generate a second motion vector corresponding to the first specific block; determining differences between the second motion vector of the first specific block and the multiple first motion vectors of the multiple blocks to generate multiple determination results, respectively; and determining multiple final motion vectors of the multiple blocks of the frame according to the multiple determination results, the multiple first motion vectors and the second motion vector.

### BACKGROUND OF THE INVENTION

### 1. Field of the Invention

The present invention relates to an image processing method.

### 2. Description of the Prior Art

In order to improve the frame rate of images for better display effects, interpolation operation is traditionally used to generate an interpolated frame between two frames, and a Motion Estimation and Motion Compensation (MEMC) mechanism is used to determine motion vectors and related image content of the interpolated frame. The current motion estimation process method divides the image frame into multiple blocks and determines the motion vector for each block. Then, the motion compensation process uses these motion vectors to calculate the motion vector and corresponding image content for the interpolated frame.

In some previous technologies, considering the cost of hardware components or the effectiveness of motion compensation, image processing circuits may reduce the size of the frames and calculate motion vectors for frames of different resolutions to determine the final motion vectors. However, since small objects in the frame are easy to disappear after the frame size is reduced, this may result in the disappearance of small objects in the interpolated frame, thereby affecting the image display quality.

### SUMMARY OF THE INVENTION

Therefore, one of the objectives of the present invention is to provide an image processing method, which can mark small objects that may disappear during the frame scaling-down process for subsequent use when generating the interpolated frames, to solve the above-mentioned problems.

According to one embodiment of the present invention, an image processing method comprises the steps of: receiving an image signal, wherein the image signal comprises a frame; performing motion estimation on multiple blocks of the frame to generate multiple first motion vectors of the multiple blocks; performing a scaling-down operation on the frame to generate a first scaled-down frame; performing the motion estimation on a first specific block of the first scaled-down frame to generate a second motion vector corresponding to the first specific block; determining differences between the second motion vector of the first specific block and the multiple first motion vectors of the multiple blocks to generate multiple determination results, respectively; and determining multiple final motion vectors of the multiple blocks of the frame according to the multiple determination results, the multiple first motion vectors and the second motion vector.

According to one embodiment of the present invention, an image processing circuit comprising a receiving circuit, a scaling circuit, a motion estimation circuit and a motion vector generation circuit is disclosed. The receiving circuit is configured to receive an image signal, wherein the image signal comprises a frame. The scaling circuit is configured to perform a scaling-down operation on the frame to generate a first scaled-down frame. The motion estimation circuit is configured to perform motion estimation on multiple blocks of the frame to generate multiple first motion vectors of the multiple blocks, and perform the motion estimation on a first specific block of the first scaled-down frame to generate a second motion vector corresponding to the first specific block. The motion vector generation circuit is configured to determine differences between the second motion vector of the first specific block and the multiple first motion vectors of the multiple blocks to generate multiple determination results, respectively, and determine multiple final motion vectors of the multiple blocks of the frame according to the multiple determination results, the multiple first motion vectors and the second motion vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image processing circuit according to an embodiment of the present invention.

FIG. 2 is a schematic diagram of two scaled-down frames and the blocks included within them according to an embodiment of the present invention.

FIG. 3 is a schematic diagram of a frame and a scaled-down frame and the blocks included within them according to an embodiment of the present invention.

FIG. 4 is a flowchart of the image processing method according to an embodiment of the present invention.

### DETAILED DESCRIPTION

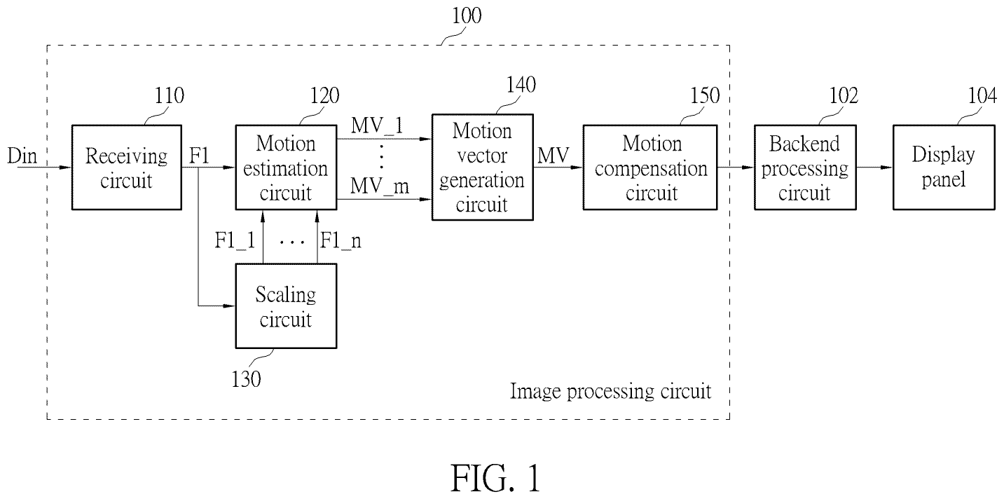

FIG. 1 is a schematic diagram of an image processing circuit 100 according to an embodiment of the present invention. As shown in FIG. 1, the image processing circuit 100 includes a receiving circuit 110, a motion estimation circuit 120, a scaling circuit 130, a motion vector generation circuit 140, and a motion compensation circuit 150. In this embodiment, the image processing circuit 100 performs the operation of enhancing the frame rate. Specifically, the image processing circuit 100 receives an image signal Din and generates multiple interpolated frames according to multiple frames of the image signal Din. These multiple frames and the multiple interpolated frames are processed by a backend processing circuit 102 and then transmitted to a display panel 104 for display.

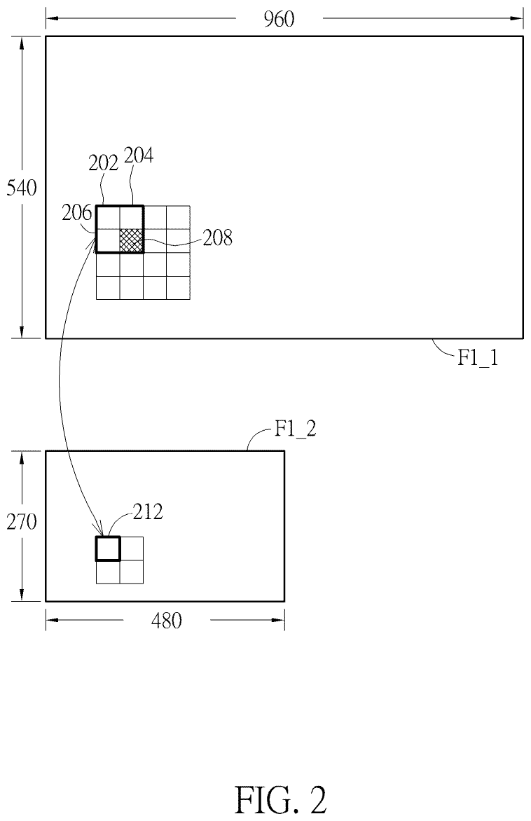

Regarding the operation of the image processing circuit 100, the receiving circuit 110 receives the image signal Din, which includes multiple frames. In order to facilitate subsequent explanation, the description will focus on one frame F1 from the multiple frames. The scaling circuit 130 scales down the multiple frames by different ratios, for example, it scales down the frame F1 by factors of 2× and 4× to generate multiple scaled-down frames F1_1 to F1_n, where n is any suitable positive integer. For instance, if the frame F1 has a resolution of 1920×1080, and the scaling circuit 130 scales down the frame F1 by 2× and 4×, the two scaled-down frames F1_1 and F1_2 will have resolutions of 960×540 and 480×270, respectively. Then, the motion estimation circuit 120 receives the multiple frames and the scaled-down frames and calculates motion vectors for multiple blocks of at least a portion of the frames. The motion vectors MV_1 to MV_m shown in FIG. 1 represent the motion vectors of the blocks in frame F1 and the scaled-down frames F1_1 to F1_n. Referring to the scaled-down frames F1_1 and F1_2 in FIG. 2, the motion estimation circuit 120 can divide the scaled-down frames F1_1 and F1_2 into multiple blocks, wherein the size of each block can be determined according to the designer's requirements, such as 4×4 pixels per block. In this case, the scaled-down frame F1_1 includes 24×135 blocks, and the scaled-down frame F1_2 includes 120×68 blocks. The motion estimation circuit 120 then determines the motion vector for each block in the scaled-down frames F1_1 and F1_2 according to the content of a reference frame. This reference frame can be a frame before or after the scaled-down frames F1_1 and F1_2. For example, in FIG. 2, four adjacent blocks (202, 204, 206, 208) in scaled-down frame F1_1 can search for matching blocks in the reference frame (for example, blocks with the smallest image content difference) to obtain the offset vectors of blocks 202, 204, 206 and 208 relative to the corresponding blocks in the reference frame, wherein these offset vectors are used as their motion vectors. Similarly, the block 212 in scaled-down frame F1_2 can search for matching blocks in its reference frame to determine its motion vector. The motion vector is the offset between the position of block 212 in the scaled-down frame F1_2 and the position of the matching block in the reference frame. In a similar manner, motion vectors for each block in frame F1 are calculated. It should be noted that since the method of calculating motion vectors is well-known to a person skilled in the art, and the focus of the present invention is not on determining the motion vector for each block from the content of the frames, the details of motion vector calculation in the motion estimation circuit 120 are omitted here.

In this embodiment, the size of each block in the scaled-down frames F1_1, F1_2, and frame F1 is the same. That is, the size of block 212 in the scaled-down frame F1_2 and each of the blocks 202, 204, 206 and 208 in the scaled-down frame F1_1, as shown in FIG. 2, can all be 4×4 pixels. Additionally, in this embodiment, the block 212 in the scaled-down frame F1_2 is generated by scaling down the four blocks 202, 204, 206 and 208 in the scaled-down frame F1_1. That is, the position of block 212 in the scaled-down frame F1_2 corresponds to the position of blocks 202, 204, 206 and 208 in the scaled-down frame F1_1.

As described in the prior art, small objects in a frame are easy to disappear after the frame is scaled down, which may lead to the disappearance of small objects in the generated interpolated frame, affecting the image display quality. For example, in FIG. 2, suppose that the block 208 in the scaled-down frame F1_1 includes a small object, and the surrounding blocks are all background. During the scaling process by the scaling circuit 130, when generating the scaled-down frame F1_2, the small object included in the block 208 may disappear. That is, the block 212 in the scaled-down frame F1_2 may not show the small object, affecting the quality of the subsequent interpolated frame generation. Therefore, the motion vector generation circuit 140 in this embodiment can mark small objects that may disappear during the frame scaling-down process to avoid the issue described in the prior art.

Specifically, the motion vector generation circuit 140 first determines whether each block in the scaled-down frame F1_2 belongs to a flat region. Taking block 212 in the scaled-down frame F1_2 as an example, the motion vector generation circuit 140 compares the motion vector of block 212 with the motion vectors of surrounding blocks, and if the difference in both direction and magnitude between the motion vector of block 212 and those of the surrounding blocks is small (for example, below a threshold value), the block 212 is considered to belong to the flat region. Otherwise, the block 212 is considered to belong to a non-flat region. In this embodiment, the block 212 is assumed to belong to a flat region. Then, the motion vector generation circuit 140 compares the motion vectors of the four blocks 202, 204, 206 and 208 in the scaled-down frame F1_1 with the motion vector of the block 212 in terms of direction or magnitude to generate four determination results. If the determination results indicate that the difference in direction or magnitude between block 202/204/206/208 and block 212 exceeds a threshold value, the motion vector generation circuit 140 marks the block, wherein the marked block in the scaled-down frame F1_1 indicates that the content of this block may disappear in the scaled-down frame F1_2 due to the scaling-down operation. In this embodiment, the difference in direction or magnitude between the motion vectors of block 208 and block 212 exceeds the threshold value, so the motion vector generation circuit 140 marks the block 208.

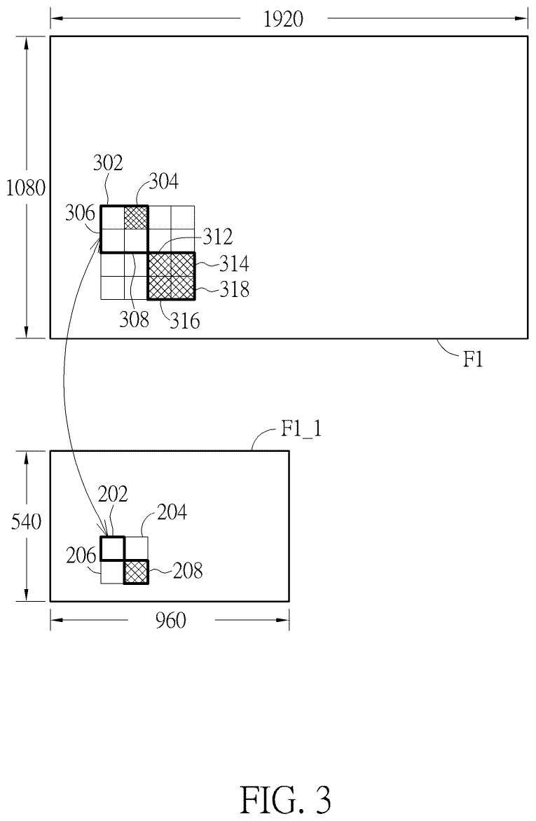

After completing the marking of blocks in the scaled-down frame F1_1, referring to FIG. 3, the motion vector generation circuit 140 determines whether each block in the scaled-down frame F1_1 belongs to a flat region. Taking the block 202 in the scaled-down frame F1_1 as an example, the motion vector generation circuit 140 compares the motion vector of block 202 with the motion vectors of surrounding blocks, and if the difference in both direction and magnitude between the motion vector of block 202 and those of the surrounding blocks is small (for example, below a threshold value), the block 202 is considered to belong to a flat region. Otherwise, the block 202 is considered to belong to a non-flat region. In this embodiment, the block 202 is assumed to belong to a flat region. Then, the motion vector generation circuit 140 compares the motion vectors of the four blocks 302, 304, 306 and 308 in frame F1 with the motion vector of block 202 in terms of direction or magnitude to generate four determination results. In this embodiment, the block 202 in the scaled-down frame F1_1 is generated by scaling down the blocks 302, 304, 306 and 308 in the frame F1, meaning that the position of block 202 in the scaled-down frame F1_1 corresponds to the position of blocks 302, 304, 306 and 308 in the frame F1. Then, if the determination results indicate that the difference in direction or magnitude between block 302/304/306/308 and block 202 exceeds a threshold value, the motion vector generation circuit 140 marks the block. The marked block in frame F1 indicates that the content of this block may disappear in the scaled-down frame F1_1 due to the scaling-down operation. In this embodiment, the difference in direction or magnitude between the motion vectors of block 304 and block 202 exceeds the threshold, so the motion vector generation circuit 140 marks the block 304.

Furthermore, since block 208 in the scaled-down frame F1_1 has been marked, the motion vector generation circuit 140 also determines the difference in direction or magnitude between the motion vectors of blocks 312, 314, 316 and 318 in frame F1 and the motion vector of block 208, to generate four determination results. In this embodiment, the block 208 in the scaled-down frame F1_1 is generated by scaling down the blocks 312, 314, 316 and 318 from the frame F1, meaning that the position of block 208 in the scaled-down frame F1_1 corresponds to the position of blocks 312, 314, 316 and 318 in the frame F1. If the determination results indicate that the difference in direction or magnitude between block 312/314/316/318 and block 208 is smaller than a threshold value, the motion vector generation circuit 140 marks the block. In this embodiment, since the difference in direction or magnitude between each of the motion vectors of blocks 302, 304, 306 and 308 with the motion vector of block 202 is smaller than the threshold value, the motion vector generation circuit 140 marks the blocks 302, 304, 306 and 308.

After completing the block marking in frame F1, the motion vector generation circuit 140 calculates the final motion vector MV for multiple blocks in frame F1 according to the motion vectors of multiple blocks in frame F1, the motion vectors of multiple blocks in the scaled-down frame F1_1, and the motion vectors of multiple blocks in the scaled-down frame F1_2. For example, referring to FIG. 2 and FIG. 3, for the block 304 in frame F1, the motion vector generation circuit 140 can perform a weighted operation (e.g., weighted summation) on the motion vector of block 304 in frame F1, the motion vector of block 202 in the scaled-down frame F1_1, and the motion vector of block 212 in the scaled-down frame F1_2 to generate the final motion vector for the block 304 in frame F1. In this embodiment, the marked blocks are given higher weights than unmarked blocks. That is, the final motion vector of block 304 is primarily determined by the motion vector of block 304 in frame F1, or the motion vector of block 304 in frame F1 can be directly used as the final motion vector for block 304 (i.e., during the calculation of the final motion vector for block 304, the weights of the motion vectors of blocks 202 and 212 are set to zero).

Additionally, for a block in frame F1, if all the corresponding blocks of the scaled-down frames F1_1 and F1_2 are not marked, the motion vector generation circuit 140 can use other mechanisms to calculate the final motion vector for that block in frame F1 according to the motion vector of the block in frame F1, the motion vector of corresponding block in the scaled-down frame F1_1, and the motion vector of corresponding block in the scaled-down frame F1_2. For example, the motion vector generation circuit 140 can determine the weight of the motion vector for the block in frame F1, the weight of the motion vector for corresponding block in the scaled-down frame F1_1, and the weight of the motion vector for corresponding block in the scaled-down frame F1_2 according to the complexity of the image content in the block in frame F1. “complexity of the image content” may include factors such as whether the transition between the background and foreground is smooth, whether the image content has complex textures or sharp edges, and other relevant information. In this embodiment, not a limitation of the present invention, the complexity of the image content can be determined by calculating the variance of the pixels within the block.

In one embodiment, if the complexity of the image content in block 302 is below a threshold value (for example, the variance of the pixels within the block is below a threshold value), or if the image content of block 302 can be determined to have a smooth transition between background and foreground, the motion vector generation circuit 140 will prioritize the motion vectors of blocks 202 and 212 from the scaled-down frames F1_1 and F1_2 to generate the final motion vector for block 302 in frame F1. In this case, the motion vectors of blocks 202 and 212 will have a higher weight than the motion vector of block 302.

In one embodiment, if the complexity of the image content in block 302 is above a threshold value (for example, the variance of the pixels within the block is above a threshold value), or if the image content of block 302 is determined to have complex textures and/or sharp edges, the motion vector generation circuit 140 will prioritize the motion vector of block 302 in frame F1 to generate the final motion vector for block 302 in frame F1. In this case, the motion vectors of blocks 202 and 212 will have a lower weight compared to the motion vector of block 302.

It should be noted that during the process of motion vector weighted calculation, the motion vectors of the blocks in the scaled-down frames F1_1 and F1_2 need to be enlarged to match the resolution of frame F1. Specifically, the motion vectors of each block in scaled-down frame F1_1 need to be enlarged by a factor of two, while the motion vectors of each block in scaled-down frame F1_2 need to be enlarged by a factor of four. Afterward, the weighted calculation can be performed.

Next, the motion compensation circuit 150 uses the contents of multiple frames of the image signal Din and the final motion vectors of each block in each frame, as generated by the motion vector generation circuit 140, to determine the motion speed of each block. Then, the motion compensation is performed to generate the interpolated frame and related information (e.g., which block of the adjacent frame is the block of the interpolated frame moved from). The motion compensation and generation of the interpolated frame are well-known to a person skilled in the art, and since the focus of this invention is not on the generation of the interpolated frame, further details will not be described here.

In summary, the image processing circuit 100 of this embodiment calculates the motion vectors of each block in both the frame F1 and the scaled-down frames F1_1 and F1_2 to determine the final motion vector of each block in frame F1. Additionally, this embodiment also marks the blocks in the frame that may lose small objects due to frame size reduction operation, providing protection for these blocks. As a result, the final motion vectors of each block in frame F1 can accurately reflect the movement direction of the objects within the frame, allowing the subsequent motion compensation circuit 150 to generate improved output image data.

It should be noted that in the embodiment described with reference to FIG. 2 and FIG. 3, the image processing circuit 100 uses three frames of different resolutions, F1, F1_1, and F1_2, to calculate the motion vectors of each block in frame F1. However, this invention is not limited to this configuration. In other embodiments, the image processing circuit 100 can use two or four frames of different resolutions to calculate the motion vectors for each block in frame F1. These alternative designs should fall within the scope of the present invention.

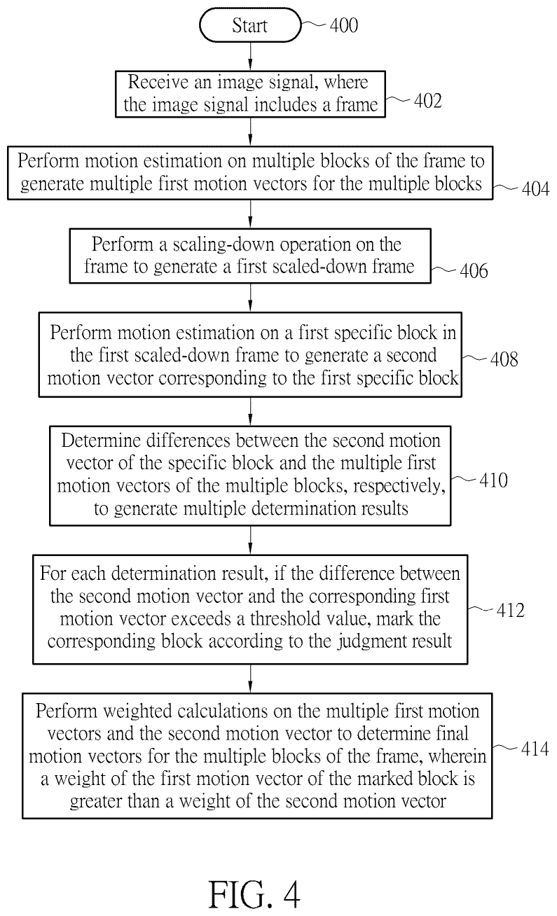

FIG. 4 is a flowchart of an image processing method according to an embodiment of the present invention. Referring to FIG. 1-FIG. 4 and above embodiments, the flow is described as follows.

Step 400: the flow starts.

Step 402: receive an image signal, where the image signal includes a frame.

Step 404: perform motion estimation on multiple blocks of the frame to generate multiple first motion vectors for the multiple blocks.

Step 406: perform a scaling-down operation on the frame to generate a first scaled-down frame.

Step 408: perform motion estimation on a first specific block in the first scaled-down frame to generate a second motion vector corresponding to the first specific block.

Step 410: determine differences between the second motion vector of the specific block and the multiple first motion vectors of the multiple blocks, respectively, to generate multiple determination results.

Step 412: for each determination result, if the difference between the second motion vector and the corresponding first motion vector exceeds a threshold value, mark the corresponding block according to the judgment result.

Step 414: perform weighted calculations on the multiple first motion vectors and the second motion vector to determine final motion vectors for the multiple blocks of the frame, wherein a weight of the first motion vector of the marked block is greater than a weight of the second motion vector.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
receiving an image signal, wherein the image signal comprises a frame;
performing motion estimation on multiple blocks of the frame to generate multiple first motion vectors of the multiple blocks;
performing a scaling-down operation on the frame to generate a first scaled-down frame;
performing the motion estimation on a first specific block of the first scaled-down frame to generate a second motion vector corresponding to the first specific block;
determining differences between the second motion vector of the first specific block and the multiple first motion vectors of the multiple blocks to generate multiple determination results, respectively; and
determining multiple final motion vectors of the multiple blocks of the frame according to the multiple determination results, the multiple first motion vectors and the second motion vector.

2. The image processing method of claim 1, wherein each of the multiple blocks has a same size as the first specific block, and a position of the first specific block in the first scaled-down frame is the same as a position of the multiple blocks in the frame.

3. The image processing method of claim 1, wherein the step of determining the multiple final motion vectors of the multiple blocks of the frame according to the multiple determination results, the multiple first motion vectors and the second motion vector comprises:
for each of the multiple determination results, if the difference between the second motion vector and the corresponding first motion vector exceeds a threshold value, marking the corresponding block according to the determination result; and
perform weighted calculations on the multiple first motion vectors and the second motion vector to determine the multiple final motion vectors of the multiple blocks of the frame, wherein a weight of the first motion vector of the marked block is greater than a weight of the second motion vector.

4. The image processing method of claim 1, wherein the multiple determination results are multiple first determination results, and the image processing method further comprises:
performing the scaling-down operation on the first scaled-down frame to generate a second scaled-down frame;
performing the motion estimation on a second specific block of the second scaled-down frame to generate a third motion vector corresponding to the second specific block;
determining differences between the third motion vector of the second specific block and the second motion vector of the first specific block to generate a second determination result; and
determining the multiple final motion vectors of the multiple blocks of the frame according to the multiple determination results, the second determination result, the multiple first motion vectors and the second motion vector.

5. The image processing method of claim 4, wherein each of the multiple blocks has a same size as the first specific block and the second specific block, a position of the first specific block in the first scaled-down frame is a same as a position of the multiple blocks in the frame, and a position of the second specific block in the second scaled-down frame includes the position of the first specific block in the first scaled-down frame.

6. The image processing method of claim 4, wherein the step of determining the multiple final motion vectors of the multiple blocks of the frame according to the multiple determination results, the second determination result, the multiple first motion vectors and the second motion vector comprises:
if the second determination result indicates that the difference between the third motion vector and the second motion vector exceeds a threshold value, marking the first specific block; and
performing weighted calculations on the multiple first motion vectors, the second motion vector and the third motion vector, to determine the multiple final motion vectors of the multiple blocks of the frame, wherein a weight of the second motion vector of the marked first specific block is greater than a weight of the third motion vector.

7. The image processing method of claim 4, further comprising:
if the differences between the multiple first motion vectors of the multiple blocks and the second motion vector are below another threshold value, and the second determination result indicates that the difference between the third motion vector and the second motion vector exceeds the threshold value, marking the first specific block and the multiple blocks;
wherein the weight of the second motion vector of the marked first specific block, and weights of the multiple first motion vectors of the marked multiple blocks, are greater than the weight of the third motion vector.

8. An image processing circuit, comprising:
a receiving circuit, configured to receive an image signal, wherein the image signal comprises a frame;
a scaling circuit, configured to perform a scaling-down operation on the frame to generate a first scaled-down frame;
a motion estimation circuit, configured to perform motion estimation on multiple blocks of the frame to generate multiple first motion vectors of the multiple blocks, and perform the motion estimation on a first specific block of the first scaled-down frame to generate a second motion vector corresponding to the first specific block; and
a motion vector generation circuit, configured to determine differences between the second motion vector of the first specific block and the multiple first motion vectors of the multiple blocks to generate multiple determination results, respectively, and determine multiple final motion vectors of the multiple blocks of the frame according to the multiple determination results, the multiple first motion vectors and the second motion vector.

9. The image processing circuit of claim 8, wherein each of the multiple blocks has a same size as the first specific block, and a position of the first specific block in the first scaled-down frame is the same as a position of the multiple blocks in the frame.

10. The image processing circuit of claim 8, wherein for each of the multiple determination results, if the difference between the second motion vector and the corresponding first motion vector exceeds a threshold value, the motion vector generation circuit marks the corresponding block according to the determination result; and the motion vector generation circuit performs weighted calculations on the multiple first motion vectors and the second motion vector to determine the multiple final motion vectors of the multiple blocks of the frame, wherein a weight of the first motion vector of the marked block is greater than a weight of the second motion vector.

11. The image processing circuit of claim 8, wherein the multiple determination results are multiple first determination results, and the scaling circuit further performs the scaling-down operation on the first scaled-down frame to generate a second scaled-down frame; the motion estimation circuit performs the motion estimation on a second specific block of the second scaled-down frame to generate a third motion vector corresponding to the second specific block; and the motion vector generation circuit determines differences between the third motion vector of the second specific block and the second motion vector of the first specific block to generate a second determination result, and determines the multiple final motion vectors of the multiple blocks of the frame according to the multiple determination results, the second determination result, the multiple first motion vectors and the second motion vector.

12. The image processing circuit of claim 11, wherein each of the multiple blocks has a same size as the first specific block and the second specific block, a position of the first specific block in the first scaled-down frame is a same as a position of the multiple blocks in the frame, and a position of the second specific block in the second scaled-down frame includes the position of the first specific block in the first scaled-down frame.

13. The image processing circuit of claim 11, wherein if the second determination result indicates that the difference between the third motion vector and the second motion vector exceeds a threshold value, the motion vector generation circuit marks the first specific block; and the motion vector generation circuit further performs weighted calculations on the multiple first motion vectors, the second motion vector and the third motion vector, to determine the multiple final motion vectors of the multiple blocks of the frame, wherein a weight of the second motion vector of the marked first specific block is greater than a weight of the third motion vector.

14. The image processing circuit of claim 11, wherein if the differences between the multiple first motion vectors of the multiple blocks and the second motion vector are below another threshold value, and the second determination result indicates that the difference between the third motion vector and the second motion vector exceeds the threshold value, the motion vector generation circuit marks the first specific block and the multiple blocks; wherein the weight of the second motion vector of the marked first specific block, and weights of the multiple first motion vectors of the marked multiple blocks, are greater than the weight of the third motion vector.
